(19) United States
(12) Patent Application Publication
(10) Pub. No.: US 2025/0016107 A1
(43) Pub. Date: Jan. 9, 2025

(54) NETWORK TRAFFIC CLASSIFICATION

(71) Applicant: Canopus Networks Assets Pty Ltd, Haymarket (AU)

(72) Inventors: Sharat Chandra MADANAPALLI, Haymarket (AU); Himal KUMAR, Haymarket (AU); Vijay SIVARAMAN, Haymarket (AU)

(73) Assignee: Canopus Networks Assets Pty Ltd, Haymarket (AU)

(21) Appl. No.: 18/710,907

(22) PCT Filed: Nov. 18, 2022
(86) PCT No.: PCT/AU2022/051384

§ 371 Date: May 16, 2024

(30) Foreign Application Priority Data
Nov. 18, 2021 (AU) 2021903718

(51) Int. Cl. H04L 47/2441; H04L 43/026; H04L 45/00

(52) U.S. Cl. CPC H04L 47/2441; H04L 43/026; H04L 45/38

(57) ABSTRACT

A network traffic classification process, including the steps of: monitoring network traffic flows to dynamically generate, for each of the network traffic flows and in real-time, time series data sets representing, for each of upstream and downstream directions of the network traffic flow, for each of a plurality of successive timeslots, and for each of a plurality of packet length bins, a packet count and a byte count of packets received within the timeslot and having one or more lengths within the corresponding packet length bin; and processing the time series data sets of each network traffic flow to classify the network flow into one of a plurality of predetermined network traffic classes, without using payload content of the network traffic flow.

### TECHNICAL FIELD

The present invention relates to network traffic classification, and in particular to a network traffic classification apparatus and process.

### BACKGROUND

Network traffic classification (NTC) is widely used by network operators for network management tasks such as network dimensioning, capacity planning and forecasting, Quality of Experience (QoE) assurance, and network security monitoring. However, traditional classification methods based on deep packet inspection (DPI) are starting to fail as network traffic is increasingly encrypted. Many web applications now use the HTTPS (HTTP with TLS encryption) protocol, and some browsers (including Google Chrome) now use HTTPS by default. Moreover, applications such as video streaming (live/on-demand) have migrated to protocols such as DASH and HLS on top of HTTPS. Non-HTTP applications (which are predominately UDP-based real-time applications such as Conferencing and Gameplay) also use various encryption protocols such as AES and Wireguard to protect the privacy of their users. With emerging protocols like TLS 1.3 encrypting server names, and HTTP/2 and QUIC enforcing encryption by default, NTC will become even more challenging.

In recent years, researchers have proposed using Machine Learning (ML) and Deep Learning (DL) based models to perform various NTC tasks such as IoT (Internet of Things) device classification, network security, and service/application classification. However, existing approaches train ML/DL models on byte sequences from the first few packets of the flow. While the approach of feeding raw bytes to a DL model is appealing due to the model's automatic feature extraction capabilities, the model usually ends up learning patterns such as protocol headers in un-encrypted applications, and server name in TLS based applications. Such models have failed to perform well in the absence of such attributes; for example, when using TLS 1.3 that encrypts the entire handshake, thereby obfuscating the server name.

It is desired, therefore, to provide a network traffic classification apparatus and process that alleviate one or more difficulties of the prior art, or to at least provide a useful alternative.

### SUMMARY

In accordance with some embodiments of the present invention, there is provided a network traffic classification process, including the steps of:
monitoring network traffic flows to dynamically generate, for each of the network traffic flows and in real-time, time series data sets representing, for each of upstream and downstream directions of the network traffic flow, for each of a plurality of successive timeslots, and for each of a plurality of packet length bins, a packet count and a byte count of packets received within the timeslot and having one or more lengths within the corresponding packet length bin; and
processing the time series data sets of each network traffic flow to classify the network flow into one of a plurality of predetermined network traffic classes, without using payload content of the network traffic flow.

In some embodiments, the predetermined network traffic classes represent respective network application types including at least two network application types of: video streaming, live video streaming, conferencing, gameplay, and download.

In some embodiments, the predetermined network traffic classes represent respective specific network applications.

In some embodiments, the processing includes dividing each byte count by the corresponding packet count to generate a corresponding average packet length, wherein the average packet lengths are processed to classify the network flow into one of the plurality of predetermined network traffic classes.

In some embodiments, the packet length bins are determined from a list of packet length boundaries.

In some embodiments, the step of processing the time series data sets includes applying an artificial neural network deep learning model to the time series data sets of each network traffic flow to classify the network flow into one of the plurality of predetermined network traffic classes.

In some embodiments, the step of processing the time series data sets includes applying a transformer encoder with an attention mechanism to the time series data sets of each network traffic flow, and applying the resulting output to an artificial neural network deep learning model to classify the network flow into a corresponding one of the plurality of predetermined network traffic classes.

In some embodiments, the artificial neural network deep learning model is a convolutional neural network model (CNN) or a long short-term memory network model (LSTM).

In some embodiments, the network traffic classification process includes processing packet headers to generate identifiers of respective ones of the network traffic flows.

In some embodiments, the network traffic classification process includes applying a transformer encoder with an attention mechanism to time series data sets representing packet counts and byte counts of each of a plurality of network traffic flows, and applying the resulting output to an artificial neural network deep learning model to classify the network flow into a corresponding one of a plurality of predetermined network traffic classes without using payload content of the network traffic flows.

In accordance with some embodiments of the present invention, there is provided a network traffic classification process, including applying a transformer encoder with an attention mechanism to time series data sets for each network traffic flow represent, for each of upstream and downstream directions of the network traffic flow, for each of a plurality of successive timeslots, and for each of a plurality of packet length bins, a packet count and a byte count of packets received within the timeslot and having one or more lengths within the corresponding packet length bin, and applying the resulting output to an artificial neural network deep learning model to classify the network flow into a corresponding one of a plurality of predetermined network traffic classes without using payload content of the network traffic flows.

Also described herein is a network traffic classification process, including the steps of:
monitoring network traffic flows to dynamically generate, for each of the network traffic flows and in real-time, time series data sets representing, for each of upstream and downstream directions of the network traffic flow, for each of a plurality of successive timeslots, and for each of a plurality of packet length bins, a count and a byte count of packets received within the timeslot and having lengths within the corresponding packet length bin; and
processing the time series data sets of each network traffic flow to classify the network flow into one of a plurality of predetermined network traffic classes.

In accordance with some embodiments of the present invention, there is provided a computer-readable storage medium having stored thereon processor-executable instructions that, when executed by at least one processor, cause the at least one processor to execute any one of the above processes.

In accordance with some embodiments of the present invention, there is provided a network traffic classification apparatus, including components configured to execute any one of the above processes.

In accordance with some embodiments of the present invention, there is provided a network traffic classification apparatus, including:
a transformer encoder with an attention mechanism configured to process time series data sets of each of a plurality of network traffic flows, wherein the time series data sets for each network traffic flow represent, packet count and a byte count of packets received within the timeslot and having one or more lengths within the corresponding packet length bin; and
an artificial neural network deep learning model configured to process output of the transformer encoder to classify the network flow into a corresponding one of a plurality of predetermined network traffic classes.

Also described herein is a network traffic classification apparatus, including:
a transformer encoder with an attention mechanism configured to process time series data sets of each of a plurality of network traffic flows; and
an artificial neural network deep learning model configured to process output of the transformer encoder to classify the network flow into a corresponding one of a plurality of predetermined network traffic classes.

### BRIEF DESCRIPTION OF THE DRAWINGS

Some embodiments of the present invention are hereinafter described, by way of example only, with reference to the accompanying drawings, wherein:

FIG. 1 is a block diagram of a network traffic classification apparatus in accordance with an embodiment of the present invention;

FIG. 2 is a flow diagram of a network traffic classification process in accordance with an embodiment of the present invention;

FIG. 3 is a schematic diagram illustrating the processing of incoming network packets to update packet and byte arrays;

FIG. 4 is a graphic representation of the byte arrays as a function of time, showing clear differences for different types of network traffic;

FIG. 5 includes schematic illustrations of CNN (top) and LSTM (bottom) architectures of the network traffic classification apparatus;

FIG. 6 is a schematic illustration of a Transformer-based Architecture of the network traffic classification apparatus;

FIG. 7 includes schematic illustrations of Application Type Classification for two data sets for respective different specific applications/providers, comparing (top diagram) weighted and per-class f1 scores of vanilla models (CNN, LSTM) and composite models (TE-CNN and TE-LSTM), and (bottom diagram) the ability of the models to learn specific application/provider-agnostic traffic patterns for identifying application types, since Set A did not include any examples from set B's applications/providers;

FIG. 8 illustrates the performance of the models for classification of specific applications/providers for video traffic (top diagram) and video conferencing traffic (bottom diagram);

FIG. 9 illustrates the effect of bin number on the weighted average f1 scores for the four different models and for the tasks of (top chart) application type classification, and (bottom chart) video provider classification (see text for details); and

FIG. 10 illustrates the effect of time bin duration on the weighted average f1 scores for each of three different classification tasks, and for (top chart) the T-LSTM model, and (bottom chart) the T-CNN model.

### DETAILED DESCRIPTION

Embodiments of the present invention include a network traffic classification apparatus and process that address the shortcomings of the prior art by building a time-series behavioural profile (also referred to herein as “traffic shape”) of a network flow, and using that (and not the content of the network flow) to classify network traffic at both the service level and the application level. In the described embodiments, network traffic flow shape attributes are determined at high-speed and in real-time (the term “real-time” meaning, in this specification, with a latency of about 10-20 seconds or less), and typically within the first &10 seconds of each network flow.

Embodiments of the present invention determine packet and byte counts in different packet-length bins without capturing any raw byte sequences (i.e., content), and providing a richer set of attributes than the simplistic byte and packet counting approach of the prior art, and operating in real-time, unlike prior art approaches that perform post-facto analysis on packet captures. Moreover, the network traffic classification process described herein is suitable for implementation with modern programmable hardware switches (for example, P4 programmable network switches with Intel Tofino ASIC processors) operating at multi-Terabit scale, and is hence suitable for deployment in large Tier-1 ISP networks.

The described embodiments of the present invention also include DL architectures that introduce an attention-based transformer encoder to Convolutional Neural Network (CNN) and Long Short Term Memory (LSTM) artificial neural networks. As described below, the transformer encoder greatly improves the performance of deep learning models because it allows them to give attention to the relevant parts of the input vector in the context of the NTC task.

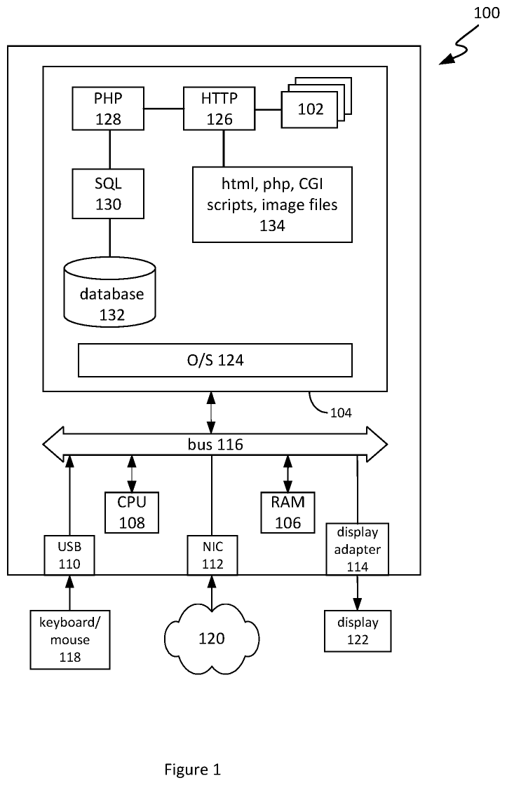

In the described embodiments, the network traffic classification process is implemented by executable instructions of software components or modules 102 of a network traffic classification apparatus 100, as shown in FIG. 1, and stored on a non-volatile storage medium 104 such as a solid-state memory drive (SSD) or hard disk drive (HDD). However, it will be apparent to those skilled in the art that at least parts of the process can alternatively be implemented in other forms, for example as configuration data of a field-programmable gate array (FPGA), and/or as one or more dedicated hardware components, such as application-specific integrated circuits (ASICs), or any combination of these various forms.

The apparatus 100 includes random access memory (RAM) 106, at least one processor 108, and external interfaces 110, 112, 114, all interconnected by at least one bus 116. The external interfaces include a network interface connector (NIC) 112 which connects the apparatus 100 to a communications network such as the Internet 120 or to a network switch, and may include universal serial bus (USB) interfaces 110, at least one of which may be connected to a keyboard 118 and a pointing device such as a mouse, and a display adapter 114, which may be connected to a display device 122.

The network device classification apparatus 100 also includes a number of standard software modules 124 to 130, including an operating system 124 such as Linux or Microsoft Windows, web server software 126 such as Apache, available at http://www.apache.org, scripting language support 128 such as PHP, available at http://www.php.net, or Microsoft ASP, and structured query language (SQL) support 130 such as MySQL, available from http://www.mysql.com, which allows data to be stored in and retrieved from an SQL database 132.

Together, the web server 126, scripting language module 128, and SQL module 130 provide the apparatus 100 with the general ability to allow a network user with a standard computing device equipped with web browser software to access the apparatus 100 and in particular to provide data to and receive data from the database 132 over the network 120.

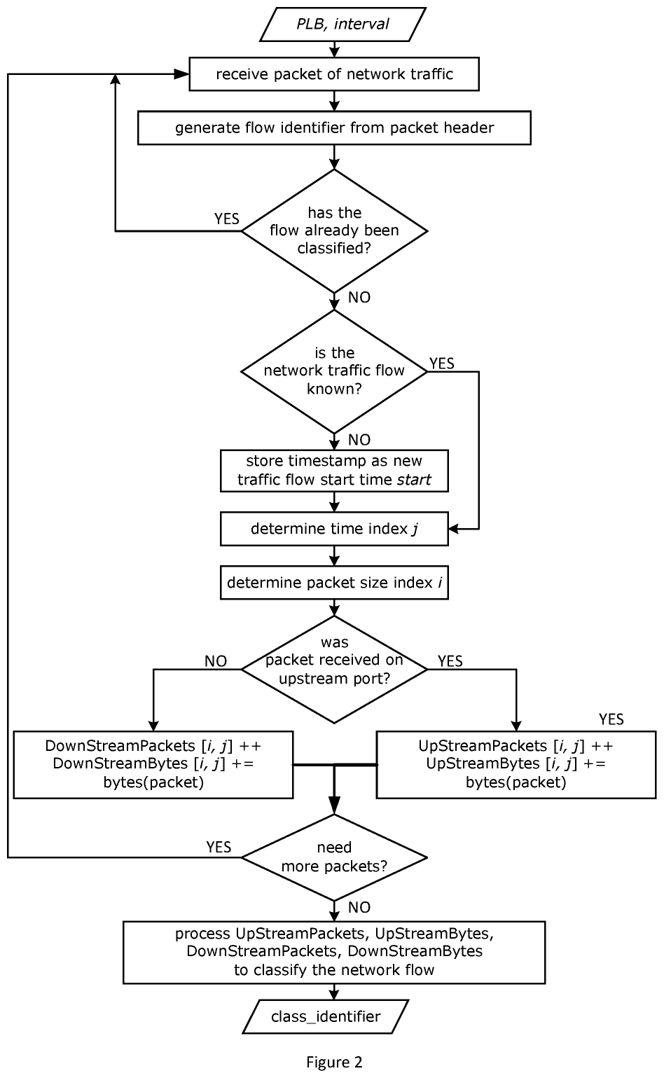

The apparatus 100 executes a network traffic classification process 200, as shown in FIG. 2, which generally involves monitoring network traffic flows received by the apparatus to dynamically generate, for each network traffic flow and in real-time, time series data sets representing packet and byte counts as a function of (binned) packet length, separately for upstream and downstream traffic flow directions.

Specifically, the time series data sets represent, for each of upstream and downstream directions of the network traffic flow, for each of a plurality of successive timeslots, and for each of a plurality of packet length bins, a count and a byte count of packets received within the timeslot and having lengths within the corresponding packet length bin. The phrase “a count and a byte count of packets received within the timeslot” is to be understood as encompassing the possibility of no packets being received within the timeslot, in which case both the count and the byte count will be zero (a common occurrence for video streaming applications).

Surprisingly, the inventors have determined that these four time series data sets, even when generated for only the first ˜10 seconds of each new traffic flow, can be used to accurately classify the network flow into one of a plurality of predetermined network traffic classes. In particular, the classification can identify not only the network application type (e.g., video streaming, conferencing, downloads, or gaming), but also the specific network application (e.g., Netflix, YouTube, Zoom, Skype, Fortnite, etc) that generated the network traffic flow.

The time series data sets are generated using counters to capture the traffic shape/behavioural profile of each network flow. Importantly, the data captured does not include header/payload contents of packets, and consequently is protocol-agnostic and does not rely on clear-text indicators such as SNI (server name indication), for example.

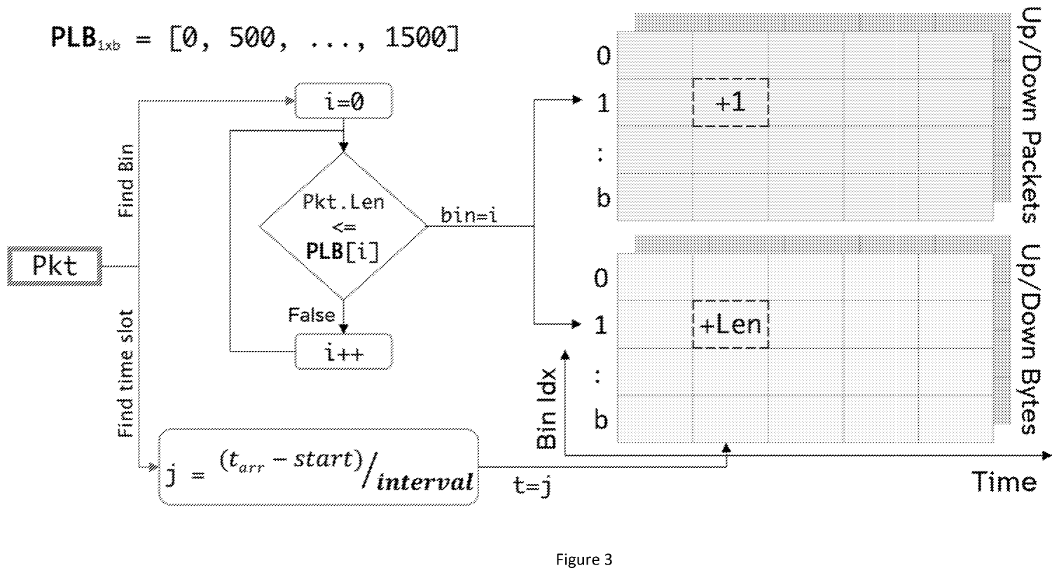

In the described embodiments, the time series data sets are implemented as four two-dimensional (“2-D”) arrays referred to herein as upPackets, downPackets, upBytes and downBytes, respectively representing counts of packets transmitted in upstream and downstream directions, and corresponding cumulative byte counts of those same packets in upstream and downstream directions. Each of these fours arrays has two dimensions, respectively representing length bins and timeslots. As shown in FIG. 3, an incoming packet is associated with a corresponding packet length bin (with index i determined from the length of the packet), and a corresponding timeslot (with index j based on its time of arrival relative to the beginning of the corresponding network flow).

The network traffic classification process accepts two input parameters, referred to herein as interval and PLB, respectively. The input parameter PLB is a list of packet length boundaries that define the boundaries of the packet length bins, and the input parameter interval defines the fixed duration of each timeslot. Thus FIG. 3 shows the resulting b discrete length bins as respective rows in each of the four tables, and the timeslots as respective columns. If the packet is an upload packet, the cell (i,j) of the upPackets array is incremented by 1, and the cell (i,j) of the upBytes array is incremented by the payload length (Len) of the packet (in bytes). Thus, after timeslot j has passed, cell (i,j) of the upPackets array stores the count (i.e., the number) of all packets that arrived in timeslot j with lengths between PLB[i−1] and PLB[i], and cell (i,j) of the upBytes array stores the total number of bytes of payload data contained in those same packets. Conversely, if the packet is a download packet, then the cells (i,j) of the downPackets and downBytes arrays is incremented in the same manner as described above.

The choice of interval and PLB determines the granularity and size of the resulting arrays. For example, a user may choose to have a relatively small interval, say 100 ms, and have 3 packet length boundaries, or a large interval, say 1 sec, and have 15 packet length boundaries (in steps of 100 Bytes). Such choices can be made depending on both the NTC task and the available compute/memory resources, as described further below.

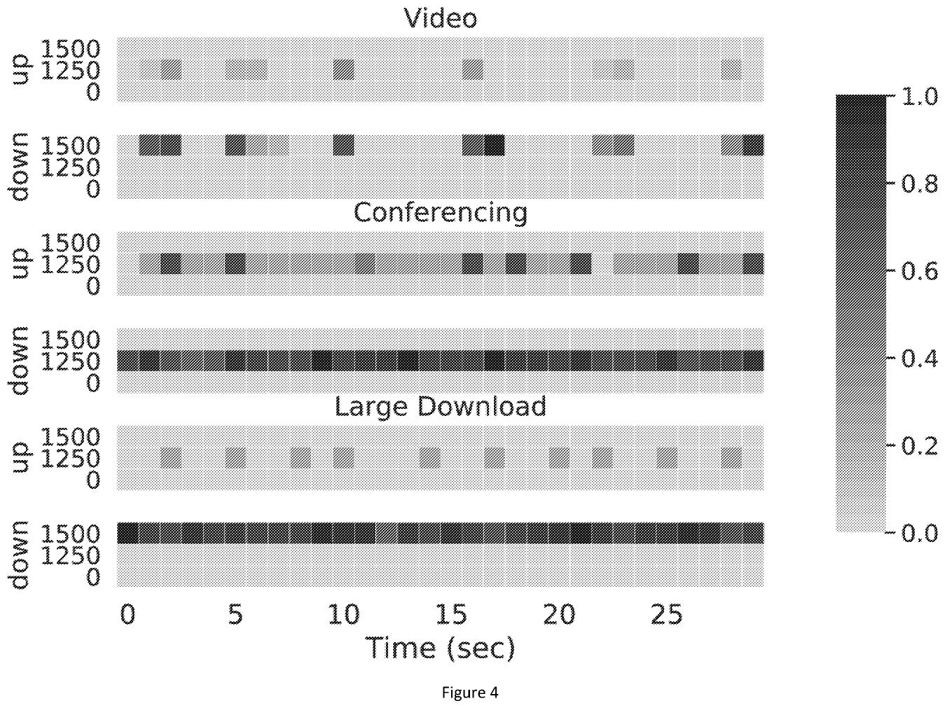

An interesting and useful feature of the time series data sets generated by the network traffic flow classification process is that, when represented visually, different application types can be easily distinguished from one another by a human observer. For example, FIG. 4 shows visual representations of the (normalized) byte count time series data sets upBytes and downBytes for 3 application types: Video, Conferencing and Large Download. The parameters used for this example are: interval=1 sec and PLB=[0,1250,1500]—intuitively these length boundaries attempt to form 3 logical bins: ACKs, Full-MTU-sized packets, and packets in between. It is apparent that the byte count time series data sets clearly demarcate the different traffic flow behaviours of these flows.

The two (upstream and downstream) video flows on top of the Figure show periodic activity—there are media requests going in the upstream direction with payload length between 0 and 1250, and correspondingly media segments are being sent by the server using full-MTU packets that fall into the packet length bin (1250,1500]. Conferencing, on the other hand, is continuously active in the mid-size packet length bin in both upload and download directions, with the downstream flow being more active due to video transfer as opposed to audio transfer in the upload direction. A large download transferred typically using HTTP-chunked encoding involves the client requesting chunks of the file to the server, which responds continuously with full-payload packets (in the highest packet length bin) until the entire file has been downloaded. This example illustrates the ability of the time series data sets to capture the markedly different traffic patterns that can be used to identify different application types.

In the described embodiments, each network traffic flow is a set of packets identified using a flow_key generated from packet headers. Typically, a 5-tuple consisting of srcip, dstip, srcport, dstport (source and destination IP addresses and port numbers) and protocol is used to generate a flow_key to identify network flows at the transport level (i.e., TCP connections and UDP streams). However, the apparatus and process are not inherently constrained in this regard. For example, in some embodiments only a 2-tuple (src and dstip) is used to generate a flow_key to identify all of the network traffic between a server and a client as belonging to a corresponding network traffic flow.

In some embodiments, the network traffic classification apparatus includes a high-speed P4 programmable switch, such as an Intel® Tofino®-based switch. Each network traffic flow is identified by generating its flow_key and matching to an entry in a lookup table of the switch, and sets of 4 registers store upstream and downstream byte counts and packet counts. A data processing component such as the computer shown in FIG. 1 periodically polls the switch registers to obtain the time-series of the counters at the defined interval. Once a network traffic flow has been classified, the registers can then be reused for a new flow.

In some embodiments, the four 2-D arrays described above for each flow are supplemented by computing two additional arrays: upPacketLength and downPacketLength by dividing the Bytes arrays by the Packets arrays in each flow direction. Thus the cell upPacketLength[i,j] (downPacketLength[i,j]) stores the average packet length of upstream (downstream) packets that arrived in timeslot j and whose packet lengths were in the packet length bin i. These arrays provide time-series average packet length measurements across the packet length bins, and have been found to be useful to identify specific applications (or, equivalently, specific providers) (e.g., Netflix, Disney, etc) within a particular application type (e.g., video), because although the overall traffic shape remains very similar between different applications/providers, the packet lengths differ.

### Transformer-Based Classification

In the described embodiments, transformer-based DL models are used to efficiently learn features from the time series data sets in order to perform NTC tasks. For the purposes of illustration, embodiments of the present invention are described in the context of two specific NTC tasks: (a) Application Type Classification (i.e., to identify the type of an application (e.g., Video vs. Conference vs. Download, etc.)), and (b) Application Provider Classification (i.e., to identify the specific application (or, equivalently, the provider of the application/service) (e.g., Netflix vs YouTube, or Zoom vs Microsoft Teams, etc.)). These NTC tasks are performed today in the industry using traditional DPI methods, and rely upon information such as DNS, SNI or IP-block/AS based mapping. However, as described above, due to the increasing adoption of encryption, these prior art methodologies will no longer work.

### Application Type Classification

In the described embodiment, the application type classification task identifies a network traffic flow as being generated by one of the following five common application types: Video streaming, Live video streaming, Conferencing, Gameplay and Downloads. A machine learning (“ML”) model is trained to classify a network traffic flow into one of these five classes. The ML model training data contains flows from different applications/providers of each application type in order to make it diverse and not limited to provider-specific patterns. For instance, the Gameplay class was defined using examples from the top 10 games active in the inventors' university network. For large downloads, although traffic from different sources may be desirable, the training data of the described embodiments includes only Gaming Downloads/Updates from the providers Steam, Origin, Xbox and Playstation, since they tend to be consistently large in size, as opposed to downloads from other providers such as Dropbox and the like which may contain smaller (e.g., PDF) files. Live video (video broadcast live for example on platforms like Twitch etc.) was intentionally separated from video on-demand to create a challenging task for the models.

### Application Provider Classification

The application type classification task identifies a specific application/provider for each application type. For the purposes of illustration, two popular application types were chosen: Video streaming and Conferencing (and corresponding separate models were trained). The objective is to detect the specific application/provider serving that content type. For Video, the network traffic classification apparatus/process was trained to detect whether the corresponding application was Netflix, YouTube, DisneyPlus or PrimeVideo (the top providers used in the inventors' university). For conferencing, the application and process were trained to detect whether the specific application/provider is Zoom, Microsoft Teams, WhatsApp or Discord: two popular video conferencing platforms, and two popular audio conferencing platforms.

TABLE 1
Classification Dataset

| | # Flows | |
|---|---|---|
| Task | per class | Classes |
| Application Type | 40,000 | Video, Live Video, |
| | | Gameplay, Conferencing |
| | | and Downloads |
| Video App Provider | 30,000 | Netflix, YouTube, Disney |
| | | Plus and Prime Video |
| Conferencing App Provider | 40,000 | Zoom, Microsoft Teams, |
| | | Whatsapp and Discord |

Dataset: To perform the classification tasks described above, labelled timeseries data sets are required to train the models. In the described embodiments, the labels are generated by a DPI platform which associates both an application type and a provider with each network traffic flow. However, it is important to note that, once the models have been trained using the labelled data, the network traffic classification process and apparatus described herein do not use as attributes any of the payload content or port and byte-based features of subsequent network flows to be classified, but instead use only the time series data sets described herein as measures of network flow behaviour.

To generate the labelled timeseries data sets for training, the “nDPI” open source Deep Packet Inspection library described at https://www.ntop.org/products/deep-packet-inspection/ndpi/was used to receive network traffic and label network flows. For each network flow, nDPI applies a set of programmatic rules (referred to as “signatures”) to classify the flow with a corresponding label. nDPI was used to label the network flows by reading the payload content and extracting SNI, DNS and port- and byte-based signatures for conferencing and gaming flows commonly used in the field. nDPI already includes signatures for the popular network applications described herein, and it is straightforward for those skilled in the art to define new signatures for other network applications.

Every record of the training data is a three tuple <timeseries,Type,Provider>. The timeseries arrays were recorded for 30 seconds at an interval of 0.5 sec and with 3 packet length bins (PLB=[0,1250,1500]). The data was filtered, pre-processed and labelled appropriately per task, as described below, before feeding it to the ML models. For the application type classification task, only the top 5-10 applications/providers of each class were used, and only the type was used as the final label. The Video class had records from only the top providers (Netflix, Disney, etc.) and with only the label “Video” after the pre-processing. Table 1 shows the approximate numbers of flows that were used to train the corresponding ML model for each task.

### Vanilla DL Models

For the purpose of explication, a brief overview of CNN and LSTM models used for NTC tasks is provided below.

### 1D CNN

CNNs are widely used in the domain of computer vision to perform tasks such as image classification, object detection, and segmentation. Traditional CNNs (2-D CNNs) are inspired by the visual circuitry of the brain, wherein a series of filters (also referred to as ‘kernels’) stride over a multi-channel (RGB) image along both height and width spatial dimensions, collecting patterns of interest for the task. However, 1-D CNNs (i.e., where filters stride over only 1 spatial dimension of an image) have been shown to be more effective for time-series classification. The fast execution speed and spatial invariance of CNNs makes them particularly suitable for NTC tasks.

The timeseries datasets described herein require no further processing before being input to a CNN (1-D CNNs are omitted for brevity) as they can be treated as a colour image. Just as a regular image has height, width and 3 color channels (RGB), the data structures described above (i.e., the timeseries datasets) have packet length bins (which can be considered to correspond to image height, for example), time slots (which can be considered to correspond to image width) and, direction and counter types together forming six channels—upPackets, downPackets, upBytes, downBytes, upPacketLengths and downPacketLengths. Thus, the set of six timeseries datasets for each network traffic flow is collectively equivalent to a 6 channeled image with dimensions (number of packet length bins, number of timesteps, 6), and is therefore also referred to herein for convenience of reference as a “timeseries image”.

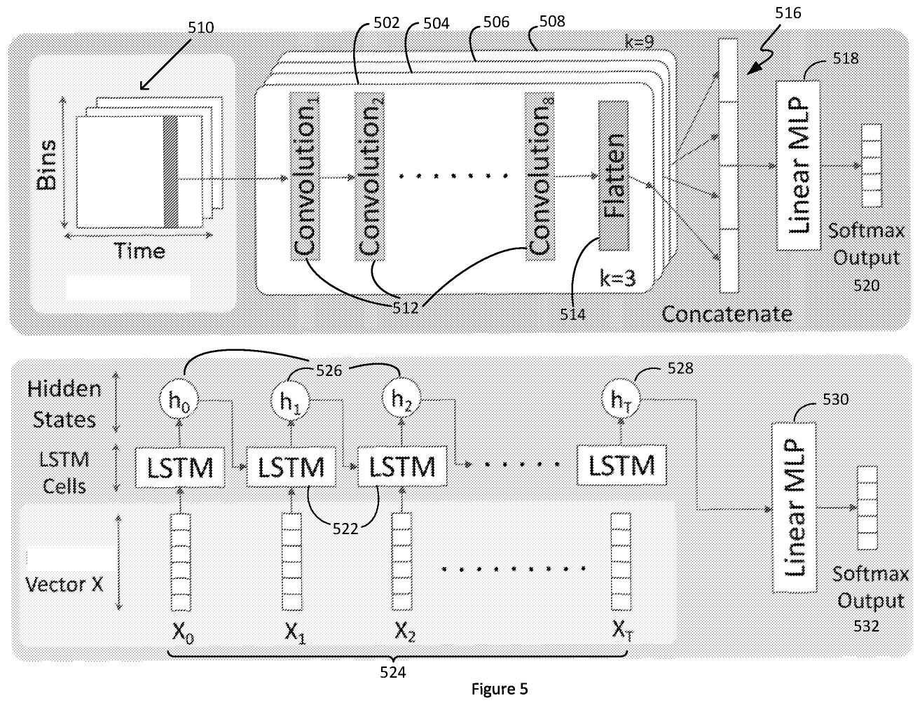

As shown in the upper portion of FIG. 5, the CNN architecture of the described embodiments includes four sub-modules 502, 504, 506, 508, each using a corresponding kernel size k to perform multiple sequential convolutions on the timeseries image 510. The four kernel sizes used in the described embodiments are k=3, 5, 7 and 9 along the timeslot axis; i.e., their ‘field of view’ is limited to the number of timeslots equal to their kernel size, but encompasses all bins and all channels and within those timeslots.

Using multiple sequential convolutions builds features in a hierarchical way, summarizing the most important features at the last convolutional layer. Eight convolution layers 512 are used in the described embodiments because the inventors found that the results showed only marginal improvements with additional layers. The output from the last layer of each sub-module is flattened to a 32-dimensional vector using a dense layer 514, and is concatenated with the outputs of the other three modules. The concatenated output (32×4) 516 is then passed to linear MLP 518 (2 dense layers with 100 and 80 neurons) whose output is then passed to a softmax layer (not shown) that outputs a probability distribution 520 over the classes of the NTC task.

### LSTM

A Long Short-Term Memory network model (“LSTM”) is a type of Recurrent neural network (“RNN”) used in tasks such as time series classification, sequence generation and the like, because they are designed to extract time-dependent features from their raw input. An LSTM processes a given sequence one time step at a time, while remembering the context from the previous time steps by using hidden states and a cell state that effectively mimic the concept of memory. After processing the entire input, it produces a condensed vector consisting of features extracted to perform the given task.

The timeseries arrays described above need to be reshaped before they can be input to an LSTM model. Accordingly, the set of timeseries arrays for each network traffic flow is converted to a time-series vector x=[X₀, X₁, X₂, . . . X_{T}], where each Xₜ is a 3*2*b dimensional vector consisting of values collected in time slot t, from the two or three array types (i.e., bytes, packets and, in some embodiments, average packet length), for each of the two flow directions (upstream and downstream), and for b packet length bins; i.e. all of the values for each time slot t.

As shown in the lower portion of FIG. 5, the LSTM architecture used in the described embodiments has one LSTM layer (of 80 neurons 522) which sequentially processes the input x 524 while keeping a hidden state h(t) 526 and a cell state c(t) (not shown). At each time slice/step t, the LSTM is fed Xₜ, and h(t−1) and c(t−1) from the previous time step, to produce new h(t) and c(t). The final hidden state h(T) 528 is then fed to a linear MLP 530 and a softmax function (not shown) to generate a probability distribution 532 over the classification labels.

Extending DL Models with Transformer Encoding

In order to improve the performance of the CNN and LSTM based models for NTC tasks, the inventors have determined that the performance of these models is improved if the encoder of a Transformer neural network deep learning model (as described below, and also referred to herein for convenience as a “Transformer”) is used to process the input prior to the CNN and LSTM models. The resulting extended DL models with Transformer Encoders (“TE”) are referred to herein for convenience as “TE-CNN” and “TE-LSTM”.

Transformers have become very popular in the field of natural language processing (“NLP”) to perform tasks such as text classification, text summarization, translation, and the like. A Transformer model has two parts: an encoder and a decoder. The encoder extracts features from an input sequence, and the decoder decodes the extracted features according to the objective. For example, in the task of German to English language translation, the encoder extracts features from the German sentence, and the decoder decodes them to generate the translated English sentence. For tasks like sentence classification, only the feature extraction is required, so the decoder part of the transformer is not used. Transformer encoder models such as “BERT” are very effective in text classification tasks. With this in mind, the inventors have implemented a transformer encoder suited for NTC tasks, as described below.

The Transformer encoder was able to outperform prior approaches to NLP due to one key innovation: Self-Attention. Prior to this, in NLP tasks, typically each word in a sentence was represented using an encoding vector independent of the context in which the word was used. For example, the word “Apple” was assigned the same vector, regardless of whether it was used to refer to a fruit or to the company, depending on the context. An NLP transformer encoder, on the other hand, uses a self-attention mechanism in which other words in the sentence are considered to enhance the encoding of a particular word. For example, while encoding the sentence “As soon as the monkey sat on the branch it broke”, the attention mechanism allows the transformer encoder to associate the word “it” with the branch, which is otherwise a non-trivial task.

Concretely, self-attention operates by assigning an importance score to all input vectors for each output vector. The encoder takes in a sequence X₀, X₁, . . . X_{T}, where each Xₜ is a k dimensional input vector representing the t-th word in the sentence, and outputs a sequence Z₀, Z₁, . . . Z_{T}, where each Zₜ is the enhanced encoding of the t-th word. For each Zₜ, the encoder learns the importance score cₜ (0<=cₜ<=1) to give to each input Xₜ, and then constructs Zₜ as follows:

$${Z}_{t} = {\sum }_{t = 0}^{T} {c}_{t} \cdot {X}_{t} , where {\sum }_{t = 0}^{T} {c}_{t} = 1$$

This is just an intuitive overview of attention, the exact implementation details are described in A. Vaswani, N. Shazeer, N. Parmar, J. Uszkoreit, L. Jones, A. N. Gomez, L. Kaiser, and I. Polosukhin, “Attention is all you need”, arXiv preprint arXiv:1706.03762, 2017 (“Vaswani”).

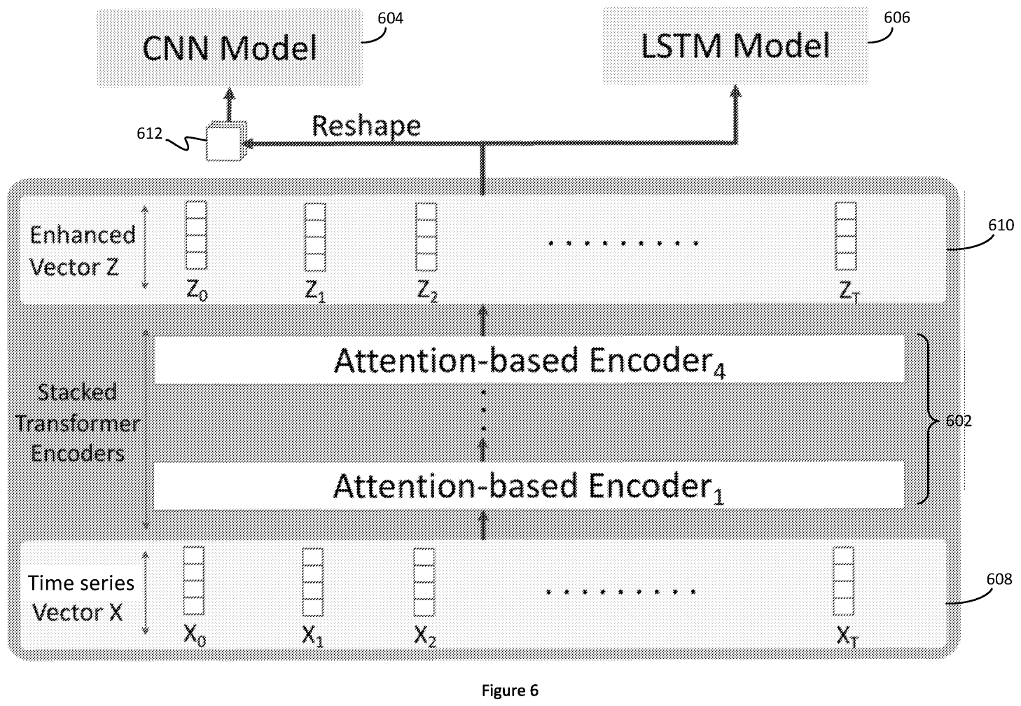

Similar to enhancing a word encoding, the inventors have determined that transformers can be used to enhance the time-series counters generated by the network traffic flow classification process, as described above. To this end, the inventors developed the architecture shown in FIG. 6, in which the TE-CNN and TE-LSTM models are CNN and LSTM models extended with Transformer Encoders. Specifically, the timeseries data sets described above are first encoded by Transformer Encoders 602 before being input to the CNN 604 and LSTM 606 models (as shown in FIG. 5). In the described embodiments, four stacked transform encoders 602 are used, each with six attention heads. Each transformer encoder is exactly as described in Vaswani, with the dimensions of key, value and query each set to 64.

The input format provided to the transformer encoder model 602 is the time-series vector X 608, as described above in the context of the input to the LSTM. The input is passed through multiple stacked encoders 602, which enhance the input with attention at each level. It was empirically found that using four stacked encoders 602 gives the best results. The output of the final encoder is an enhanced vector z 610 with the same dimensions as X 608. This enhanced vector z 610 is provided as an input to both models 604, 606.

For the TE-LSTM, the vector z 610 is directly fed to the LSTM model 606 with no modification. For TE-CNN however, the vector z 610 is first converted to a six-channel image 612 (the reverse of the process of converting a six-channel image to the input X as described above). The image formatted input 612 is then fed to the CNN model 604. Since the input X and the output z are of the exact same dimensions, the transformer encoder component is “pluggable” into the existing CNN and LSTM architectures of FIG. 5, requiring no modifications to them.

Like most DL-models, the learning process (even with the transformer encoders) is end-to-end; all of the model parameters, including attention weights, are learned using stochastic gradient descent (“SGD”) to reduce the error of classification. Intuitively, in the case of the TE-CNN, the CNN 604 updates the encoder weights to improve the extraction of features using visual filters, whereas in the case of the TE-LSTM, the LSTM 606 updates the encoder weights to improve the extraction of time-series features. Irrespective of the underlying model architecture, the transformer encoder 602 is capable of enhancing the input to suit the operation of the underlying model 604, 606, with the result that the combined/composite models (TE+the underlying ‘vanilla’ model) learn and perform better than the underlying vanilla models 604, 606 alone, across the range of NTC tasks, as shown below.

### Examples

### Training and Evaluation

To demonstrate the NTC capabilities of the models, they were trained for 2 tasks: (a) application-type classification, and (b) application/provider classification for video and conferencing application types. The training dataset contained timeseries arrays as described above, labelled with both application type and application/provider.

In addition to evaluating the prediction performance of the models for these classification tasks, the impact of the input parameters interval and PLB were also evaluated. In particular, the models' performance was evaluated for different binning configurations and also for different data collection durations of 10 sec and 20 sec. For all of these configurations, the training process, as described below, remained the same.

### Training

For each NTC task (refer Table 1), the data was divided into three subsets of 60%, 15% and 25%, for training, validation, and testing, respectively. The subsets were selected to contain approximately the same number of examples from each class (for each task). All the DL models were trained for 15 epochs, where in each epoch the entire dataset is fed to the model in batches of 64 flows at a time. Cross-entropy loss was calculated for each batch, and then the model parameters were learned through back-propagation using the standard Adam optimizer with an empirically tuned learning rate of 10-4. After each epoch, the model was tested on the validation data, and if the validation results began to degrade, then the training process was halted. This ensures that the model is not over-fitting to the training data, a phenomenon referred to in the art as “early stopping”. These training parameters (and the models' hyper-parameters) can be tuned specifically to make incremental improvements to performance. However, the aim of this example was to evaluate the performance of different model architectures, rather than to optimize the model parameters for each NTC task. Hence, the training process was selected to be simple and consistent across all of the models and tasks in order to provide a fair comparison.

TABLE 2
Dataset split for type classification

| Application | Set-A | Set-B |
|---|---|---|
| Type | Applications/Providers | Applications/Providers |
| Video | Netflix, Youtube, Disney | AmazonPrime, Facebook |
| Conferencing | MS teams, Zoom, Discord | Skype, Whatsapp, Hangout |
| Gameplay | Genshin Impact, LoL, | CoD: Black Ops Cold War, |
| | CoD, WOW, CS: GO, | Fortnite, Overwatch, Halo |
| | | Reach, Battlefront II, |
| | | Hearthstone |
| Downloads | Steam, XboxLive | Playstation, Oculus, Origin |
| Live Video | Twitch, Seven Live | — |

### Model Evaluation

The underlying (‘vanilla’) models (i.e., the CNN and LSTM models 604, 606) and the composite models (i.e., the TE-CNN and TE-LSTM models) were evaluated for application type classification and application/provider classification tasks using timeseries data sets as inputs, and configured with 3 packet length bins (0, 1250, 1500) and collected over 30 seconds at 0.5 sec interval (i.e., 60 time slots).

### Type Classification

For the application type classification task, the following application type labels were used: Video, Live Video, Conferencing, Gameplay, and Download. As shown in Table 2, the dataset was divided into 2 mutually exclusive sets A and B, based on application/provider. The model was trained on 75% of the data (with 60% used for training and 15% used for validation) of set A, and two evaluations were performed: (i) using the remaining 25% of set A, and (ii) on all of the data in set B. The class “Live Video” was excluded because it contained only two applications/providers.

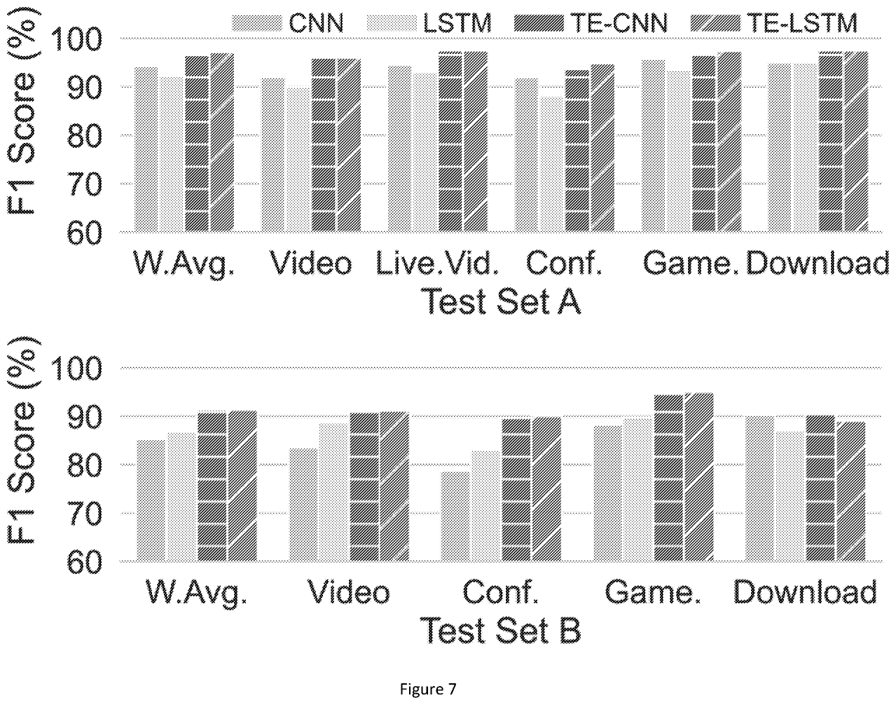

As shown in the top chart of FIG. 7, the evaluation on set A compares weighted and per-class f1 scores of both vanilla models (CNN 604, LSTM 606) and the composite models (TE-CNN and TE-LSTM). Firstly, all four models have weighted average f1-scores of at least 92%, indicating the effectiveness of the timeseries data sets for capturing the traffic shapes and distinguishing application types. Secondly, the composite models consistently outperform the vanilla models 604, 606 (by 2-6%), demonstrating the effectiveness of the transformer encoders.

The evaluation on set B (lower chart in FIG. 7) tests the ability of the models to learn application/provider-agnostic traffic patterns for identifying application types, since they were never shown examples from set B's providers. While the performance drops across the models, as expected, it is apparent that the composite models outperform the vanilla models by a significant margin (of 6-11%). This demonstrates that the composite models can generalize better than vanilla DL models due to their attention-based encoding enhancements.

### Provider Classification

To evaluate application/provider classification, the aim was to classify the top application/providers for the two application types Video and Conferencing; specifically, to classify amongst Netflix, YouTube, Disney and AmazonPrime for Video, and Microsoft Teams, Zoom, Discord and WhatsApp for Conferencing. This classification task is inherently more challenging, since all the providers belong to the same application type and hence have substantially the same traffic shape. Consequently, the models need to be sensitive to intricate traffic patterns and dependencies such as packet length distribution and periodicity (in the case of video) to be able to distinguish between (and thus classify amongst) the different providers.

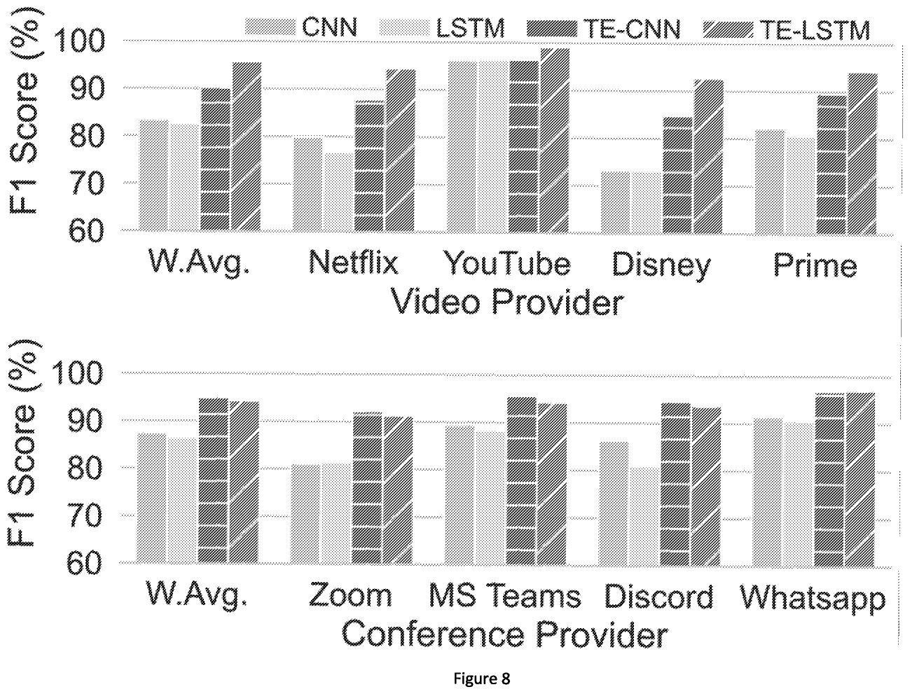

As shown by the top chart of FIG. 8, for video provider classification the composite models perform better that the vanilla models, with a 12% gain in the weighted average (e.g., TE-LSTM vs LSTM). The inventors believe that TE-LSTM outperforms other models because it can better pick up the periodic traffic patterns (transfer of media followed by no activity, as shown in FIG. 4) that exist in the video applications. For instance, it was observed (in the dataset) that YouTube transfers media every 2-5 seconds, whereas Netflix transfers media every 16 seconds. Transformers enrich the timeseries data sets by learning to augment this information, and thus improve classification accuracy.

Similarly, for conference provider classification (as shown in the lower chart of FIG. 8), the composite models outperform the vanilla models by 7% on average (e.g., TE-CNN vs. CNN). For this task, TE-CNN performs slightly better than TE-LSTM because this task predominantly relies on packet length distributions, which tend to be specific to different conferencing applications, rather than the periodic patterns observed in video applications.

To summarize, the composite models are able to learn complex patterns beyond just traffic shape, outperforming the vanilla models 604, 606 in the challenging tasks of video application/provider classification and conference application/provider classification.

### Input Parameter Evaluation

The effect of reducing the number of bins on the classification f1-scores across tasks was also investigated. Further, the models were re-trained and evaluated with data collected for less than 30 seconds to investigate the trade-off between classification time and model performance.

### Effect of Bin Parameters

The evaluations described above are for 3 packet length bins, with PLB=[0,1250,1500]. The impact of reducing these bins to only 2, with PLB=[1250,1500], and only 1, with PLB=[1500] on the performance of the models is described below. There are two obvious choices for reducing the three bins to two: either (a) merge bins 2 and 3, or (b) merge bins 1 and 2. In practice, it was found that the latter configuration provided the best performance, so this is the configuration evaluated in the following. Accordingly, the resulting 2-bin configuration tracks the counters of less-than-MTU packet length bins (0<=pkt.len<=1250) and close-to-MTU packet length bins (>=1250). The case of a single bin corresponds to no binning at all; i.e., the total byte and packet counts of each flow are counted, without any packet length based separation.

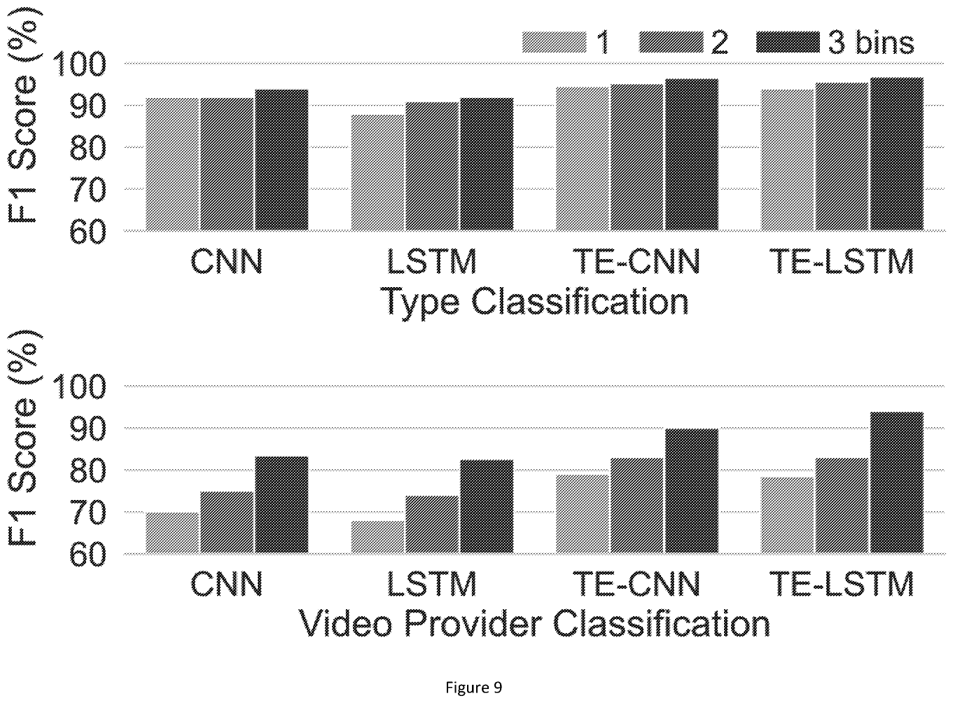

Every model was re-trained and evaluated for each of the 3 bin configurations described above and for the same NTC tasks (Application Type Classification and Video application/Provider Classification), and the resulting weighted average f1 scores are shown in FIG. 9. It is apparent that the f1 scores across the models and tasks generally improve with increasing packet length bin number. However, the performance improvement also depends on the task complexity. For the application type classification task, the vanilla models 604, 606 improved by less than 2% per additional packet length bin, and the difference was even less significant for the composite models. For the video application/provider classification task however, the performance increment is significant, since the task is more challenging and benefits from the finer grained data provided by additional binning. In contrast, in the case of Video Conference Provider Classification (not shown), the number of bins was found to have little to no impact on f1 scores, because almost all of the packets were assigned to the same bin (0<=pkt.len<=1250).

It is apparent from the above that the configuration of the timeseries data sets can be determined in dependence on the NTC task at hand. It should also be borne in mind that higher numbers of bins imply increased memory usage, which is especially expensive in programmable switches which typically have limited memory. Accordingly, the evaluation described herein assists with balancing the trade-off between the number of bins and memory usage to achieve a particular target accuracy for a given NTC task.

### Time Period Analysis

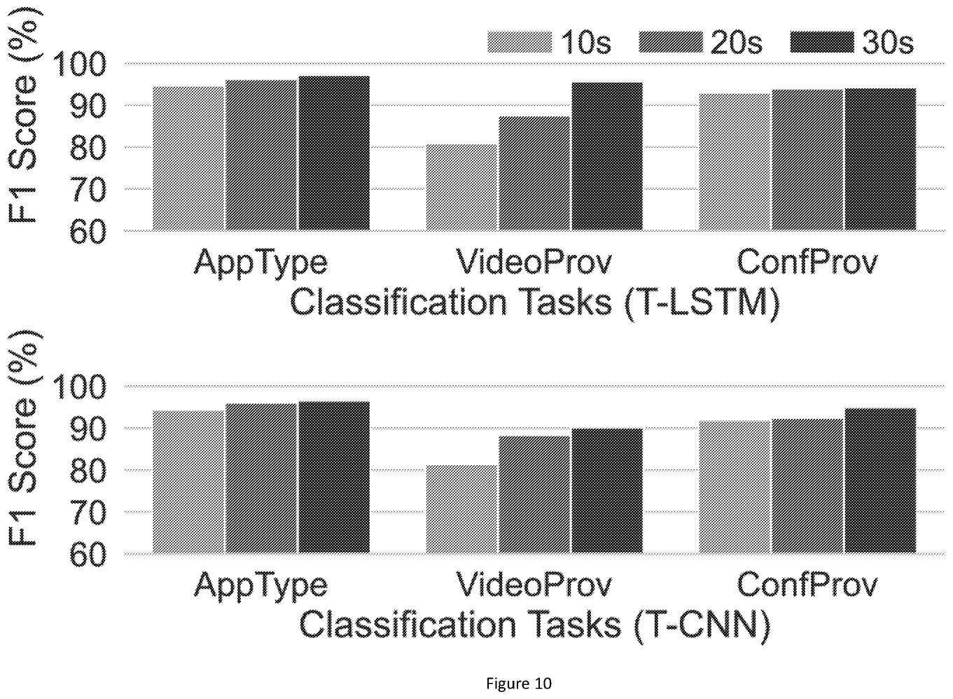

The effect of the time period for which the timeseries data is collected was also investigated for each NTC task. The composite models were re-trained and evaluated (the vanilla models 604, 606 are omitted from the following for brevity) on timeseries data sets collected for 10 sec, 20 sec and 30 sec. The upper and lower charts in FIG. 10 show the weighted average f1-scores of the TE-LSTM and TE-CNN models, respectively, across the three different NTC tasks (x-axis). It is apparent that both composite models are able to accurately classify application types with about 95% f1 score with only 10 seconds of data, with only a relatively marginal increase to 97% when 30 seconds of data are used. Similarly, the conferencing provider classification results do not vary significantly with increasing data collection time, as a conference call tends to exhibit similar behaviour over the investigated time ranges. In contrast, the accuracy of video application/provider classification improved significantly with the duration of data collection. This is due to the periodic nature of the corresponding flows, which repeat at relatively long intervals (e.g., 16 seconds for Netflix).

Accordingly, the parameters of the timeseries data sets (i.e., PLB, time duration, interval) can be configured depending upon the NTC task, the available compute/memory resources, and the required performance in terms of classification speed and overall accuracy.

It will be apparent that the network traffic classification apparatus and process described herein can accurately classify network traffic in real-time (the term “real-time” being understood in this specification as within a time of ≈10 seconds) and at scale by using only the behavioural patterns of network flows, and agnostic to the actual content of those flows. In particular, the timeseries data-structures described herein efficiently capture network traffic behaviour, and are suitable for implementation in high-speed programmable network switches. Additionally, the composite models described herein and constituted by combining deep learning with transformer-encoders outperform prior art DL models. In particular, the evaluations described above demonstrate that the combination of the described timeseries data sets with the composite deep learning models can classify application type and providers at scale with high accuracies and in real-time, without any knowledge or consideration of the content of the network traffic being classified.

Many modifications will be apparent to those skilled in the art without departing from the scope of the present invention.

1. A network traffic classification process, including the steps of:
monitoring network traffic flows to dynamically generate, for each of the network traffic flows and in real-time, time series data sets representing, for each of upstream and downstream directions of the network traffic flow, for each of a plurality of successive timeslots, and for each of a plurality of packet length bins, a packet count and a byte count of packets received within the timeslot and having one or more lengths within the corresponding packet length bin; and
processing the time series data sets of each network traffic flow to classify the network flow into one of a plurality of predetermined network traffic classes, without using payload content of the network traffic flow.

2. The network traffic classification process of claim 1, wherein the predetermined network traffic classes represent respective network application types including at least two network application types of: video streaming, live video streaming, conferencing, gameplay, and download.

3. The network traffic classification process of claim 1, wherein the predetermined network traffic classes represent respective specific network applications.

4. The network traffic classification process of claim 1, wherein the processing includes dividing each byte count by the corresponding packet count to generate a corresponding average packet length, wherein the average packet lengths are processed to classify the network flow into one of the plurality of predetermined network traffic classes.

5. The network traffic classification process of claim 1, wherein the packet length bins are determined from a list of packet length boundaries.

6. The network traffic classification process of claim 1, wherein the step of processing the time series data sets includes applying an artificial neural network deep learning model to the time series data sets of each network traffic flow to classify the network flow into one of the plurality of predetermined network traffic classes.

7. The network traffic classification process of claim 1, wherein the step of processing the time series data sets includes applying a transformer encoder with an attention mechanism to the time series data sets of each network traffic flow, and applying the resulting output to an artificial neural network deep learning model to classify the network flow into a corresponding one of the plurality of predetermined network traffic classes.

8. The network traffic classification process of claim 6, wherein the artificial neural network deep learning model is a convolutional neural network model (CNN) or a long short-term memory network model (LSTM).

9. The network traffic classification process of claim 1, including processing packet headers to generate identifiers of respective ones of the network traffic flows.

10. A network traffic classification process, including applying a transformer encoder with an attention mechanism to time series data sets for each network traffic flow represent, for each of upstream and downstream directions of the network traffic flow, for each of a plurality of successive timeslots, and for each of a plurality of packet length bins, a packet count and a byte count of packets received within the timeslot and having one or more lengths within the corresponding packet length bin, and applying the resulting output to an artificial neural network deep learning model to classify the network flow into a corresponding one of a plurality of predetermined network traffic classes without using payload content of the network traffic flows.

11. A computer-readable storage medium having stored thereon processor-executable instructions that, when executed by at least one processor, cause the at least one processor to execute the process of:
monitoring network traffic flows to dynamically generate, for each of the network traffic flows and in real-time, time series data sets representing, for each of upstream and downstream directions of the network traffic flow, for each of a plurality of successive timeslots, and for each of a plurality of packet length bins, a packet count and a byte count of packets received within the timeslot and having one or more lengths within the corresponding packet length bin; and
processing the time series data sets of each network traffic flow to classify the network flow into one of a plurality of predetermined network traffic classes, without using payload content of the network traffic flow.

12. A network traffic classification apparatus, including at least one processor configured to:
monitor network traffic flows to dynamically generate, for each of the network traffic flows and in real-time, time series data sets representing, for each of upstream and downstream directions of the network traffic flow, for each of a plurality of successive timeslots, and for each of a plurality of packet length bins, a packet count and a byte count of packets received within the timeslot and having one or more lengths within the corresponding packet length bin; and
process the time series data sets of each network traffic flow to classify the network flow into one of a plurality of predetermined network traffic classes, without using payload content of the network traffic flow.

13. A network traffic classification apparatus, including:
a transformer encoder with an attention mechanism configured to process time series data sets of each of a plurality of network traffic flows, wherein the time series data sets for each network traffic flow represent, packet count and a byte count of packets received within the timeslot and having one or more lengths within the corresponding packet length bin; and
an artificial neural network deep learning model configured to process output of the transformer encoder to classify the network flow into a corresponding one of a plurality of predetermined network traffic classes.

14. The apparatus of claim 13, wherein the predetermined network traffic classes represent respective network application types including at least two network application types of: video streaming, live video streaming, conferencing, gameplay, and download.

15. The apparatus of claim 13, wherein the predetermined network traffic classes represent respective specific network applications.
